(19) United States
(12) Patent Application Publication
(10) Pub. No.: US 2023/0130495 A1
(43) Pub. Date: Apr. 27, 2023

(54) Apparatus For Cooking With Ventilated Hot Air And/Or For Grilling Food

(71) Applicant: SEB S.A., Ecully (FR)

(72) Inventor: Johann Petitallot, Ecully (FR)

(73) Assignee: SEB S.A., Ecully (FR)

(21) Appl. No.: 17/970,133

(22) Filed: Oct. 20, 2022

(30) Foreign Application Priority Data
Oct. 21, 2021 (FR) 2111158

(51) Int. Cl. F24C 15/32; F24C 7/06; A47J 37/06; A23L 5/10

(52) U.S. Cl. CPC F24C 15/325; F24C 7/067; A47J 37/0641; A47J 37/0664; A23L 5/15; A23L 5/17; A23V 2002/00

(57) ABSTRACT

A cooking apparatus includes a heating device intended to be placed opposite a cooking chamber, and a ventilation member arranged to generate a flow of hot air, the flow of hot air is heated by the heating device wherein the heating device includes a first heating member and a second heating member, the apparatus having a processing unit configured to propose an operating mode of the cooking apparatus in which at least one of the first heating member and the second heating member and the ventilation member are activated simultaneously to perform a function of cooking food placed in the cooking chamber, and to propose another operating mode in which only one of the first heating member or the second heating member is activated to perform a function of grilling or browning food disposed in the cooking chamber, and the ventilation member is deactivated.

### TECHNICAL FIELD

The present invention relates to a multi-functional cooking appliance, making it possible to carry out either cooking of food by circulation of ventilated hot air in a cooking chamber containing the food, or grilling of food placed in the cooking chamber, or even a combination of the two, i.e., cooking of food by circulation of ventilated hot air followed by surface grilling of said food at the end of cooking.

The invention relates particularly to the design of the heating device for performing cooking and/or grilling of food. Broiling is the process of grilling or browning food on the surface.

### STATE OF THE ART

There are cooking appliances that allow cooking by circulating hot ventilated air, for example those marketed by the applicant under the name ACTIFRY® or under the name FRY DELIGHT®. Such appliances comprise a cooking chamber in which is placed a pot which allows the reception of food to be cooked either by placing it directly in the pot or by placing it in a removable basket disposed in said pot. These appliances comprise, in the upper part, above the cooking chamber, a turbine driven in rotation by a motor placed above said turbine, a heating element of the resistive type being placed under the turbine. An air circuit allows air to circulate under the action of the turbine, this air passing through the heating element in order to be heated, said hot air circulating in the cooking chamber and cooking the food in the pot or the basket. The calories generated by the heating element are diffused throughout the cooking chamber, which allows a balance between the power generated by the heating element and the air flow of the turbine, the heating element thus maintaining a surface temperature that does not generate too much radiation, which avoids toasting the food placed on the surface in the bowl or the basket.

Such appliances do not offer a grilling function with perfect control of the cooking process. Indeed, if the objective was to have a grilling function allowing to grill or to brown the surface of the food at the end of cooking, the full power of the heating element without any ventilation would be too important for these apparatuses which would then be in overheating, since the aforementioned heating element is adapted for the realization of cooking by a circulation of ventilated hot air. This would result in charring of the food placed on the surface in the pot or in the basket placed in the pot. In addition, this overheating could damage the electronic and electrical components of the device, such as the electronic board of the treatment unit and the motor of the ventilation unit

### PRESENTATION OF THE INVENTION

The invention alleviates all or part of these disadvantages by implementing a cooking appliance designed both to cook food by a circulation of ventilated hot air and to grill or bake surface foods placed in a cooking chamber.

To this end, the cooking apparatus according to the invention comprises a heating device intended to be placed opposite a cooking chamber, and a ventilation member arranged to generate a flow of hot air, the flow of hot air being heated by said heating device. According to the invention, the heating device comprises a first heating member and a second heating member. Thus, the first and second heating elements are included in one and the same heating device. In addition, the apparatus comprises a processing unit configured to propose a mode of operation of the cooking apparatus in which at least one of the first heating member and the second heating member, and the ventilation member are activated simultaneously to carry out a function of cooking the food placed in the cooking chamber, and to propose another mode of operation in which only one of the first heating member or the second heating member is activated to carry out a function of grilling or browning of the food placed in the cooking chamber, the ventilation member being deactivated.

Thus, the processing unit can independently control the two heating elements on the heating device and the ventilation element, which allows a better control of the heat radiation above the cooking chamber either for cooking by circulating ventilated hot air by simultaneously activating one or both heating elements and the ventilation element so as to generate calories which are diffused throughout the cooking chamber and to maintain a balance between the generated calories and the air flow, thus making it possible to maintain a surface temperature of the two heating elements which does not generate too much radiation, or for a grilling function by activating only one of the two heating elements so that, at full power, the said heating element activated without air flow (inactive ventilation element) generates a radiation which is less significant than the radiation generated by the first heating element and the second heating element combined, but which is sufficient to grill the surface of the food in the cooking enclosure without charring it and without causing overheating of the appliance.

This invention therefore goes against what is usually practiced to perform a roasting or browning function where, generally, all the heating elements are activated.

Thus, the appliance will be able to offer various cooking possibilities with ventilated hot air, adapted to the food to be cooked, to the recipes implemented and to the types of cooking desired, depending on the activation of the first heating element and/or the second heating element with the ventilation element.

The appliance according to the invention will also have two modes of operation for grilling, either by activating the first heating element alone or by activating the second heating element alone, the radiation generated by the first heating element and that generated by the second heating element, taken separately, without activating the ventilation element, offering the possibility of grilling or browning the surface of the food in the cooking chamber according to two different types of radiation, without charring the food and without causing overheating of the appliance.

According to an embodiment of the apparatus subject to the invention, the first heating member and the second heating member are arranged in a same plane under the ventilation member. Alternatively, the first heating element and the second heating element can be arranged in two separate planes below the ventilation element.

According to the invention, the first heating element has a power of between 500 Watts and 1000 Watts, preferably between 700 Watts and 900 Watts, preferably equal to 750 or 900 Watts.

According to the invention, the second heating element has a power of between 500 Watts and 1000 Watts, preferably between 600 Watts and 800 Watts, preferably equal to 600 or 750 Watts.

According to an embodiment of the apparatus subject to the invention, the second heating member has a power less than or equal to the power of the first heating member.

According to the invention, the total power of the first heating element and the second heating element combined, i.e., operating simultaneously, is between 1000 Watts and 2000 Watts, preferably between 1300 Watts and 1700 Watts, preferably equal to 1350 or 1650 Watts.

According to the embodiment of the invention, the first heater comprises a first resistive heating tube and the second heater comprises a second resistive heating tube, the first resistive heating tube and the second resistive heating tube being nested within each other. Several nestings will be possible, which will advantageously allow for adapting the radiation of the first resistive heating tube and that of the second resistive heating tube.

In addition, said apparatus may include the cooking chamber. In this case such a cooking appliance can be a hot air cooker or an oven.

The cooking appliance according to the invention may also be a cooking accessory without a cooking chamber and comprising support means intended to interact with support means placed on a rim of a cooking chamber of another appliance.

Another object of the present invention is a cooking method implemented by a cooking apparatus as previously described, and comprising a mode of operation in which at least one of the first heater and the second heater, and the fan member are activated simultaneously to perform a function of cooking food placed in the cooking chamber, followed by another mode of operation in which only one of the first heater or the second heater is activated and the fan member is deactivated to perform a function of grilling or browning food placed in the cooking chamber.

### BRIEF DESCRIPTION OF THE FIGURES

The features and advantages of the invention will become apparent from the following description based on figures, among which:

FIG. 1 illustrates a cross-sectional view of a design example of a cooking device according to the invention;

FIG. 2 illustrates an embodiment of a heating device on the cooking apparatus subject of the invention;

FIG. 3 shows a first arrangement of a first resistive heating tube and a second resistive heating tube constituting a heating device on the cooking appliance subject of the invention;

FIG. 4 shows a second arrangement of a first resistive heating tube and a second resistive heating tube constituting a heating device on the cooking appliance subject of the invention;

FIG. 5 shows a third arrangement of a first resistive heating tube and a second resistive heating tube constituting a heating device on the cooking appliance subject of the invention;

FIG. 6 depicts a fourth arrangement of a first resistive heating tube and a second resistive heating tube constituting a heating device on the cooking apparatus subject of the invention.

FIG. 7 depicts a fourth arrangement of a first resistive heating tube and a second resistive heating tube constituting a heating device on the cooking apparatus subject of the invention.

FIG. 8 diagrams the device electronics shown in FIG. 1.

### DETAILED DESCRIPTION OF THE INVENTION

In the remainder of the description, the term appliance refers to the cooking appliance that is the subject of the invention, unless otherwise indicated in the text.

The terms “upper,” “lower,” “top,” “bottom,” “front,” “back,” “side,” “vertical,” “horizontal,” “left,” “right” that may be used in this description will be used in consideration of the normal position of the elements of the device placed in a functional configuration, facing the user on a horizontal support plane such as a table or kitchen top.

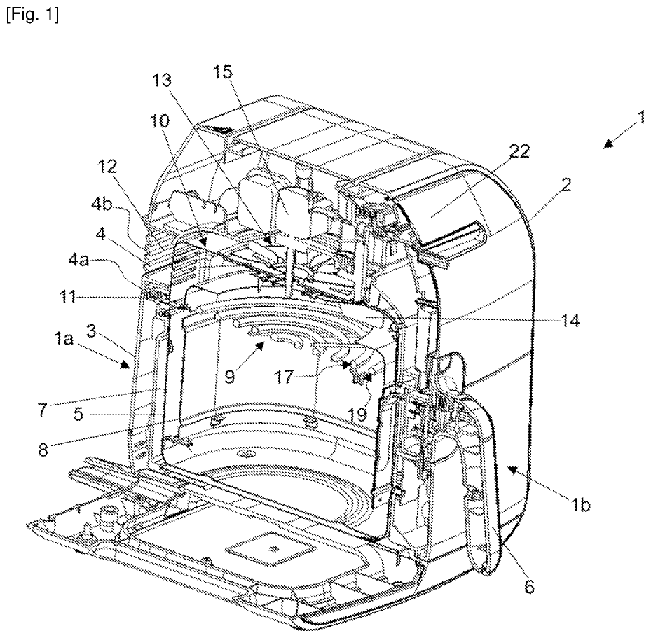

FIG. 1 shows an example of the design of a device 1 according to the invention. This appliance is of the hot air cooking type, which comprises a rear side 1a and a front side 1b. The device 1 has a shell 2, one wall 3 of which, arranged on the side of the rear side 1a, is provided with a grid 4. The shell 2 is open on the side of the front face 1b and allows the insertion of a bowl 5 in the manner of a drawer, said bowl 5 being removable and handled by means of a handling handle 6. The shell 2 defines a cooking chamber 7 which allows the reception of the pot 5, a basket 8 being placed removably in this pot 5. The food to be cooked can be placed either in the basket 8 or directly in the bowl 5, depending on the type of culinary preparation.

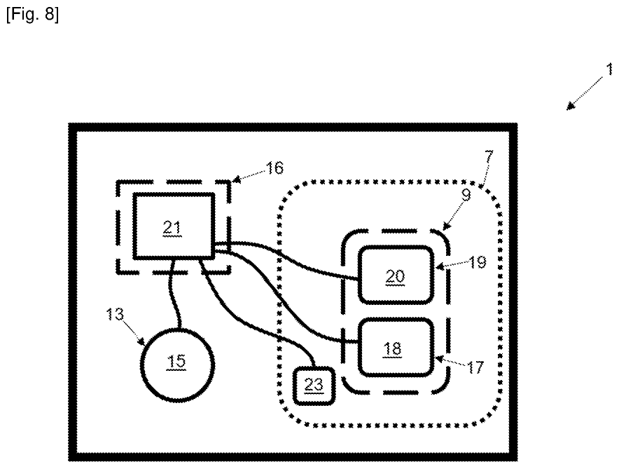

As shown in FIG. 1, a heating device 9 is arranged inside the shell 2, above the cooking chamber 7. An air circulation device 10 draws in fresh air through a lower part 4a of the grate 4, which enters through an air intake 11 and is then fed to the heating device 9 for heating and finally to the vessel 5 located in the cooking chamber 7. The heated air circulates in the pot 5, which may include the basket 8, and is then discharged outside the appliance 1, through an extraction port 12, which opens at the upper part 4b of the grid 4. The air circulation device 10 comprises a ventilation member 13 comprising a turbine 14 driven in rotation by an electric motor 15; the ventilation member 13 makes it possible to convey the air from its entry by the suction mouth 11 to its exit by the extraction mouth 12. The various electrical components of the device 1, including the heating device 9 and the motor 15, are connected to a processing unit 16 (shown in FIG. 8), which includes an electronic card 21 programmed to control the heating device 9 and the motor 15.

The invention can also be applied to other types of cooking appliances, such as those marketed by the applicant under the name ACTIFRY® or accessories such as the one marketed under the trade name Extra Crisp for the appliance marketed by the applicant under the name Cookeo®.

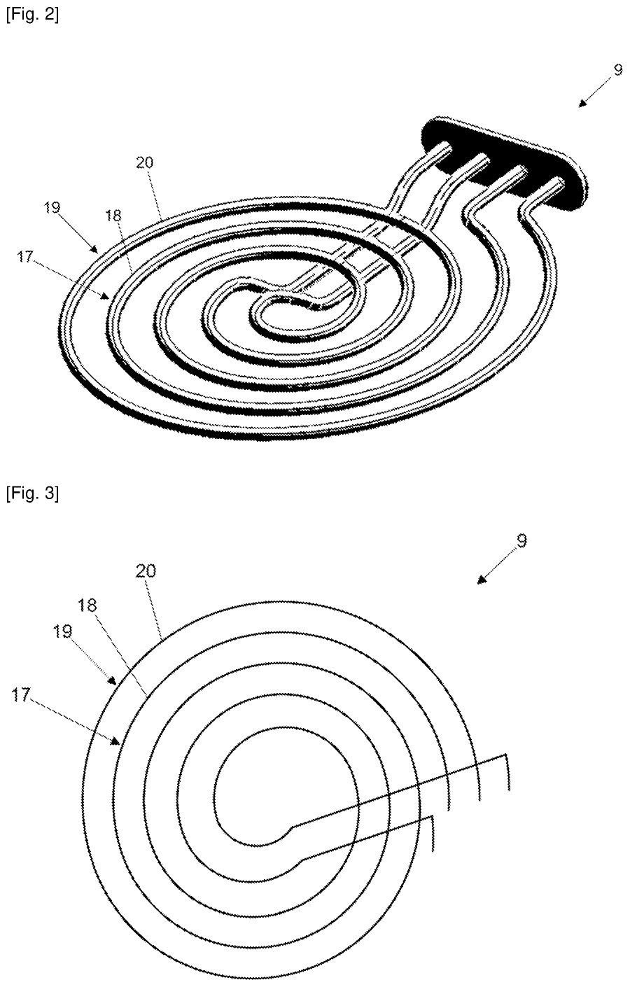

The invention relates more specifically to the design of the heating device 9 and to the processing unit 16 managing the control of said heating device 9 and of the motor 15 of the ventilation member 13. According to the invention, as illustrated in FIGS. 2 to 7, the heating device 9 comprises a first heating member 17 consisting of a first resistive heating tube 18 and a second heating member 19 consisting of a second resistive heating tube 20. The first resistive heating tube 18 and the second resistive heating tube 20 are nested within each other and arranged in the same plane, with different configurations illustrated in FIGS. 3 through 7. The first resistive heating tube 18 and the second resistive heating tube 20 are preferably of identical design, i.e., they are made of the same material and have an identical tube cross-section and identical resistivity, with only the arrangement and possibly the lengths of the two resistive heating tubes 18, 20 varying.

In FIG. 3, the first resistive heating tube 18 and the second resistive heating tube 20 are placed next to each other and spirally wound. The second resistive heating tube 20 is placed on the outer side with respect to the first resistive heating tube 18 and thus has a longer tube length than the first resistive heating tube 18. The first resistive heating tube 18 thus has a higher power than the second resistive heating tube 20.

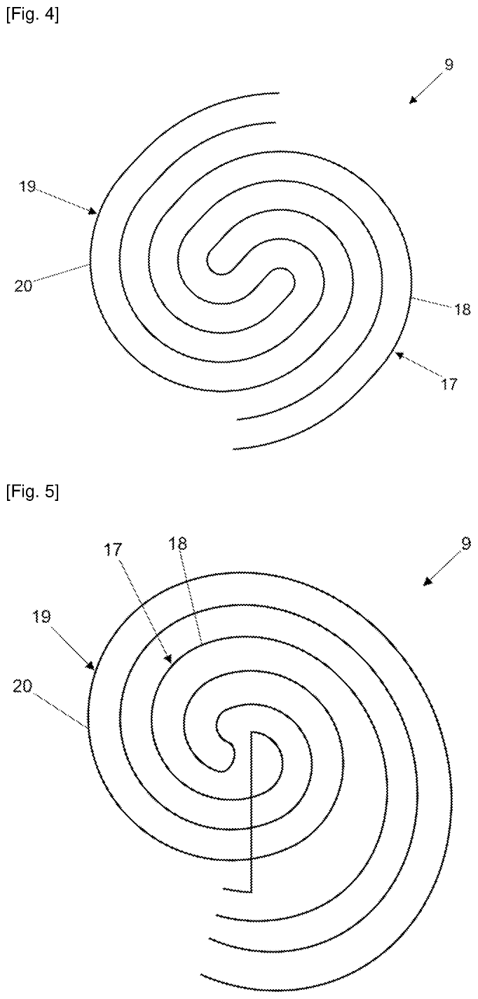

In FIG. 4, the first resistive heating tube 18 and the second resistive heating tube 20 are each folded back on themselves and then rolled up on each other in opposite directions like two snails. The first resistive heating tube 18 and the second resistive heating tube 20 have more or less the same tube length. Thus, the first resistive heating tube 18 has the same power as the second resistive heating tube 20.

In FIG. 5, the second resistive heating tube 20 is folded on itself and then placed next to the first resistive heating tube 18, and then they are wound on top of each other in the same direction in a spiral. The second resistive heating tube 20 is therefore more or less twice the length of the first resistive heating tube 18. Thus, the first resistive heating tube 18 has a power that is twice that of the second resistive heating tube 20.

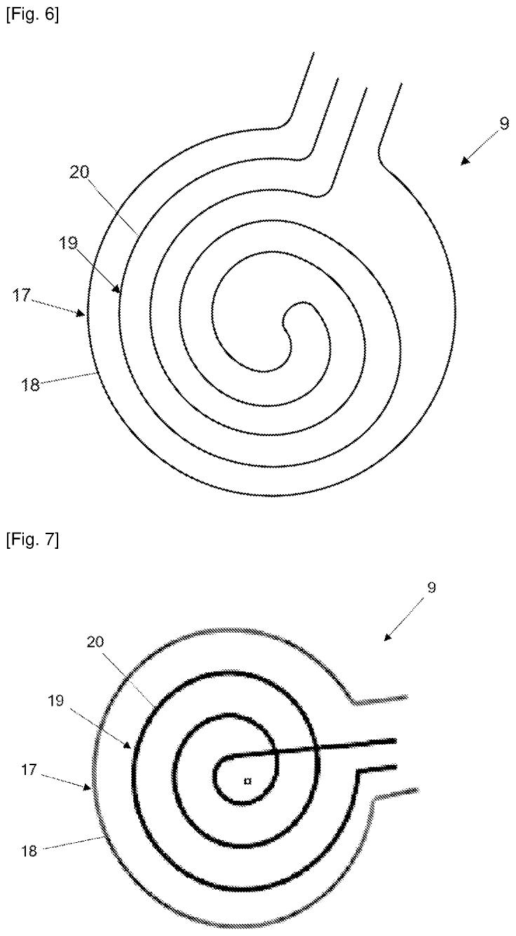

In FIG. 6, the second resistive heating tube 20 is folded on itself and then spirally wound. The first resistive heating tube 18 is arranged in a circle around the second resistive heating tube 20. The second resistive heating tube 20 is therefore about three times the length of the first resistive heating tube 18. Thus, the first resistive heating tube 18 has a power that is about three times that of the second resistive heating tube 20.

In FIG. 7, the second resistive heating tube 20 is spirally wound. The first resistive heating tube 18 is arranged in a circle around the second resistive heating tube 20. The second resistive heating tube 20 is therefore about twice the length of the first resistive heating tube 18. Thus, the first resistive heating tube 18 has a power that is about twice that of the second resistive heating tube 20. This configuration has the advantage of being easier to manufacture.

FIGS. 3 to 7 show, in a non-limiting way, various possibilities of nesting the first resistive heating tube 18 and the second resistive heating tube 20 in order to play on their lengths and thus on their respective powers. It would be possible to arrange the first resistive heating tube 18 in a plane offset below that of the second resistive heating tube 20, in particular to position the first resistive heating tube 18 closer to the surface of the food placed in the bowl or basket and thus improve the toasting function upon activation of said first resistive heating tube 18 alone.

As shown in FIG. 8, the processing unit 16 comprises an electronic card 21 which is programmed to manage the activation of the first resistive heating tube 18, of the second resistive heating tube 20 and of the motor 15 of the ventilation device 13 according to the culinary preparation which will be selected by the user on an interface (not illustrated) placed on the front panel 22 of the device 1.

According to a first basic version of the device 1, the electronic board 21 is programmed to implement the following operating modes:
when the user selects a culinary recipe requiring cooking by circulation of ventilated hot air, then the appliance switches to a first operating mode in which the electronic board 21 simultaneously activates the first resistive heating tube 18, the second resistive heating tube 20 and the motor 15 driving the turbine 14 so as to create a circulation of air which is heated by the two resistive heating tubes 18, 20;
when the user selects a culinary recipe that requires grilling or browning of the surface of the food at the end of the cooking process, the appliance switches to a second operating mode in which the electronic board 21 activates only the first resistive heating tube 18, the second resistive heating tube 20 and the motor 15 being inactive, so as to create a heat radiation capable of browning the surface of the food placed in the bowl or in the basket;
when the user selects a culinary recipe requiring cooking by circulation of ventilated hot air and then grilling or browning the food on the surface at the end of cooking, the appliance switches to its first operating mode in which the electronic board 21 first simultaneously activates the first resistive heating tube 18, the second resistive heating tube 20 and the motor 15 driving the turbine 14 in order to carry out the cooking by circulation of ventilated hot air and then, at the end of the cooking, switches to its second operating mode in which the said electronic board 21 actuates only the first resistive heating tube 18, the second resistive heating tube 20 and the motor 15 being inactive, in order to carry out the browning of the surface of the food placed in the vat or in the basket.

A temperature sensor 23 (shown in FIG. 8) is used to measure the temperature in the cooking chamber 7, the temperature measurement being communicated to the electronic board 21 which manages the activation of said resistive heating tubes 18, 20 to regulate the temperature in the cooking chamber 7. Temperature control is of the type “All or Nothing.”

According to a second version of the appliance 1, taking up the aforementioned first version, the electronic board 21 is programmed to additionally implement the following operating mode: when the user selects a culinary recipe requiring cooking by circulation of hot air ventilated with a milder temperature, then the appliance switches to a third operating mode in which the electronic board 21 simultaneously activates the first resistive heating tube 18 and the motor 15 driving the turbine 14 so as to create a circulation of air which is heated by the first resistive heating tube 18, the second resistive heating tube 20 remaining inactive.

According to a third version of the appliance 1 incorporating the aforementioned first version and possibly the aforementioned second version, the electronic board 21 is programmed to additionally implement the following operating mode: when the user selects a culinary recipe requiring cooking by circulation of hot ventilated air with a milder temperature different from that of the second version, then the appliance switches to a fourth operating mode in which the electronic board 21 simultaneously activates the second resistive heating tube 20 and the motor 15 driving the turbine 14 so as to create a circulation of air which is heated by the second resistive heating tube 20, the first resistive heating tube 18 remaining inactive.

According to a fourth version of the device 1, incorporating the aforementioned first version and possibly the aforementioned second version and/or the aforementioned third version, the electronic board 21 is programmed to additionally implement the following operating modes:
when the user selects a culinary recipe requiring grilling, browning or browning on the surface of the food, then the appliance switches to a fifth operating mode in which the electronic board 21 activates only the second resistive heating tube 20, the first resistive heating tube 18 and the motor 15 being inactive so as to create with the second resistive heating tube 20 a heat radiation on the food placed in the pot or in the basket, weaker than the heat radiation generated by the first resistive heating tube 18 when it operates alone, one can thus have two browning levels,
when the user selects a culinary recipe requiring cooking by circulation of ventilated hot air and then grilling or browning the food on the surface at the end of cooking, then the appliance switches to its first, third or fourth operating mode in which the electronic board 21 first simultaneously activates the first resistive heating tube 18 and/or the second resistive heating tube 20 and the motor 15 driving the turbine 14—depending on the version of the appliance 1 used and the cooking temperature required in the cooking chamber 7, then, at the end of cooking, switches to its fifth operating mode in which the said electronic card 21 actuates only the second resistive heating tube 20, the first resistive heating tube 18 and the motor 15 being inactive.

Thus, the appliance 1 can carry out grilling or even gratins by using two different radiations according to the nature of the food which is placed in the pot 5, either by lighting only the first resistive heating tube 18 in its second mode of operation, or by lighting only the second resistive heating tube 20 in its fifth mode of operation.

All these versions of appliances are thus arranged to implement a cooking process comprising a first cooking step followed by a second browning step. The cooking steps can be implemented in the first, third or fourth mode of operation in which at least one of the two resistive heating tubes 18, 20 as well as the motor 15 driving the turbine 14 are simultaneously activated. As for the gilding steps, they can be implemented during the second or fifth operating mode in which only one of the two resistive heating tubes 18, 20 is activated and the motor 15 driving the turbine 14 is inactive.

A ventilated mode with only one of the two resistors also makes it easier to regulate low temperatures without exceeding the set point, for example 40° C. for yogurts or 100° C. for slow cooking, in particular for a duration of 7 hours for cooking lamb.

The first resistive heating tube 18 is sized to deliver a power between 500 Watts and 1000 Watts, preferably between 700 Watts and 900 Watts preferably equal to 750 or 900 Watts. Similarly, the second resistive heating tube 20 is sized to deliver between 500 Watts and 1000 Watts, preferably between 600 Watts and 800 Watts preferably equal to 600 or 750 Watts. The first resistive heating tube 18 and the second resistive heating tube 20 are sized to together deliver a power between 1000 Watts and 2000 Watts, preferably between 1300 Watts and 1700 Watts, preferably equal to 1350 or 1650 Watts, depending on the food capacity that can be received by pot 5 of the apparatus 1.

The appliance 1 can be equipped with various additional accessories that will be used for cooking by circulating hot ventilated air and/or for cooking by surface grilling of the food. For example, the apparatus 1 may include a paddle (not shown) for scraping the interior of the bowl 5 and stirring the food in said bowl 5, which paddle may be used with ventilated hot air circulation cooking and/or with broiling. The appliance 1 can also include a support (not illustrated) to be placed on the upper contour of the bowl 5 or of the basket 8 placed in this bowl 5, said support allowing the reception of skewers (not illustrated), said appliance 1 then working in grilling mode.

Other characteristics remain possible within the context of the invention.

1. A cooking apparatus comprising:
a heating device for placing next to a cooking chamber, the heating device having a first heating member and a second heating member,
a ventilation member arranged to generate airflow, that is configured to be heated by the heating device, and
a processing unit configured to provide:
a first operating mode of the cooking apparatus in which the ventilation member and at least one of the first heating member and the second heating member are activated simultaneously to perform a cooking function of food arranged in the cooking chamber, and second operating mode in which the first heating member or the second heating member is activated to perform a grilling or browning function of food arranged in the cooking chamber, and the ventilation member is deactivated.

2. An apparatus according to claim 1, wherein the first heating member and the second heating member are arranged in a same plane below the ventilation member.

3. An apparatus (1) according to claim 1, wherein the first heating member comprises a power of between 500 Watts and 1000 Watts, preferably of between 700 Watts and 900 Watts, preferably equal to 750 or 900 Watts.

4. An apparatus according to claim 1, wherein the second heating member comprises a power of between 500 Watts and 1000 Watts, preferably of between 600 Watts and 800 Watts preferably equal to 600 or 750 Watts.

5. An apparatus according to claim 1, wherein the second heating member has a power less than or equal to the power of the first heating member.

6. An apparatus according to claim 1, wherein the total power of the first heating member and the second heating member combined is between 1000 Watts and 2000 Watts, preferably between 1300 Watts and 1700 Watts, preferably equal to 1350 or 1650 Watts.

7. An apparatus of claim 1, wherein the first heating member comprises a first resistive heating tube and the second heating member comprises a second resistive heating tube, and wherein the first resistive heating tube and the second resistive heating tube are nested within one another.

8. An apparatus of claim 1, comprising the cooking chamber.

9. An apparatus according to claim 1, wherein the apparatus is a cooking accessory that lacks a cooking chamber and comprises a first support means for interacting with a second support means placed on a rim of a cooking chamber of another appliance.

10. A cooking method carried out by a cooking apparatus according to claim 1, comprising a first operating mode in which at least one of the first heating member and the second heating member, and the ventilation member are activated simultaneously to perform a cooking function of food placed in the cooking chamber followed by a second operating mode in which the first heating member or the second heating member is activated and the ventilation member is deactivated in order to perform a function of grilling or browning food placed in the cooking chamber.
